(19) United States
(12) Patent Application Publication
(10) Pub. No.: US 2022/0391447 A1
(43) Pub. Date: Dec. 8, 2022

(54) METHOD AND APPARATUS FOR RETRIEVING A DATA PACKAGE

(71) Applicant: BRITISH TELECOMMUNICATIONS PUBLIC LIMITED COMPANY, London (GB)

(72) Inventors: Carla DI CAIRANO-GILFEDDER, London (GB); Anasol PENA RIOS, London (GB); Hani HAGRAS, London (GB); Gilbert OWUSU, London (GB)

(21) Appl. No.: 17/891,207

(22) Filed: Aug. 19, 2022

Related U.S. Application Data
(62) Division of application No. 16/626,687, filed on Dec. 26, 2019.

(30) Foreign Application Priority Data
Jun. 27, 2017 (EP) 17178173.5

(51) Int. Cl. G06F 16/907; G06F 16/22; G06F 16/242; G06N 5/02

(52) U.S. Cl. CPC G06F 16/907; G06F 16/2237; G06F 16/2423; G06N 5/02

(57) ABSTRACT

This invention provides a method for ranking contextual data of a plurality of data packages in a Knowledge Management System (KMS) as a computer system configured to store information on the maintenance of an apparatus, wherein each data package of the plurality of data packages includes a data part relating to maintenance of the apparatus, a first metadata part for the data part having a first metadata value and representing a first contextual information type and a second metadata part for the data part having a second metadata value and representing a second contextual information type, the method comprising the steps of: receiving a first and second relevance value for the first and second contextual information type respectively for a first data package, wherein the first and second relevance values represent the relevance of the first and second contextual information types of the first data part to the maintenance of the apparatus; receiving a third and fourth relevance value for the first and second contextual information type respectively for a second data package, wherein the third and fourth relevance values represent the relevance of the first and second contextual information types of the second data part to the maintenance of the apparatus; determining a first ranking value for the first contextual information type based on the first and third relevance values; determining a second ranking value for the second contextual information type based on the second and fourth relevance values; and storing the first and second ranking values in the KMS. The present invention also provides a method for retrieving data packages, including the steps of: receiving a data package request including a first metadata value for the first contextual information type and a second metadata value for the second contextual information type; and retrieving a first data package of the plurality of data packages based on at least one of the first and second metadata values of the data package request, the first and second ranking values, and at least one of the first and second metadata values of each data package of the plurality of data packages.

### CROSS REFERENCE TO RELATED APPLICATION

This is a divisional application of U.S. application Ser. No. 16/626,687, filed on Dec. 26, 2019, which is the U.S. national phase of International Application No. PCT/EP2018/061598, filed on May 4, 2018, which designated the U.S. and is based on and claims the benefit of priority from European Application No. 17178173.5, filed on Jun. 27, 2017. The disclosures of the above-identified applications are incorporated herein by reference in their entirety.

### FIELD OF THE INVENTION

The present invention relates to a method and apparatus for ranking metadata of a data package in a computing system, such that the data package may be retrieved based on the ranked metadata.

### BACKGROUND TO THE INVENTION

Many industries rely on computer systems which must be maintained by service engineers to ensure high standards of performance and reliability. This presents a challenge to the service provider, who must invest significant time and money to train a team of engineers in the various maintenance operations. This is further complicated when the computer systems include specialised equipment. A further problem is presented by service engineers having to travel to remote locations to service computer systems, such that some resources (such as documentation or training videos) are not available, so that a service engineer may have insufficient knowledge to complete a task. This puts further emphasis on the requirement to sufficiently train all service engineers (and the consequent investment in time and money) prior to their employment on a real-life maintenance task.

To alleviate the above problem, it is possible to provide assistance to a service engineer by providing the resources required for the service engineer to learn (or remind himself/herself of) the relevant knowledge and/or techniques to complete the maintenance task via a mobile computing device. The resources may take the form of, for example, an Internet or Intranet site having documentation, training videos, or a Frequently Asked Questions (FAQ) section.

As mobile computing devices have gained greater computational power and a greater number of sensors (such as cameras, accelerometers, gyroscopes), it has become possible for such devices to be used for Mixed Reality (MR) applications, including Augmented Reality (AR) and Virtual Reality (VR). MR generally refers to systems which mix real and virtualised (i.e. computer-generated) environments. VR refers to highly-immersive virtual environments in which the visual (and often, auditory) environment is entirely virtualised. Commercially available VR systems include the HTC Vive and Oculus Rift, but may also include any mobile computing device with suitable sensors and applications to provide such an environment (such as a mobile telephone, or smartphone, combined with suitable head-mounting equipment, such as the Samsung Galaxy Gear VR, Google Cardboard or Google Daydream). AR refers to a predominately real-world environment, with the addition of virtualised elements which may seamlessly interact with the real-world environment. AR systems may be provided as an application via a mobile computing device, such as a smartphone, or via dedicated hardware, such as Microsoft Hololens.

These MR devices, in particular AR devices, may be provided as part of a Remote Assistance System (RAS) as a powerful training tools for service engineers. The multitude of sensors in the AR device, including the camera, coupled with the computational power, allow the RAS to detect and categorise objects in the user's field of view and, in turn, provide personalised information and support. For example, a telecommunications service engineer maintaining a network node in a remote location may capture the make and model of components of the network node via the AR device's camera. The RAS may then classify the component, and personalise the delivered visual/audio training literature such that it is only relevant for that specific component.

A RAS typically utilises a media server for storing one or more Knowledge Assets (KA), e.g. documentation or training video files, for each computing apparatus being maintained. The KAs may be stored in the media server with metadata identifying, for example, the apparatus' make and model, its location, etc, to convey contextual information about the KA.

### SUMMARY OF THE INVENTION

According to a first aspect of the invention, there is provided a method for ranking contextual data of a plurality of data packages in a Knowledge Management System (KMS) as a computer system configured to store information on the maintenance of an apparatus, wherein each data package of the plurality of data packages includes a data part relating to maintenance of the apparatus, a first metadata part for the data part having a first metadata value and representing a first contextual information type and a second metadata part for the data part having a second metadata value and representing a second contextual information type, the method comprising the steps of: receiving a first and second relevance value for the first and second contextual information type respectively for a first data package, wherein the first and second relevance values represent the relevance of the first and second contextual information types of the first data part to the maintenance of the apparatus; receiving a third and fourth relevance value for the first and second contextual information type respectively for a second data package, wherein the third and fourth relevance values represent the relevance of the first and second contextual information types of the, second data part to the maintenance of the apparatus; determining a first ranking value for the first contextual information type based on the first and third relevance values; determining a second ranking value for the second contextual information type based on the second and fourth relevance values; and storing the first and second ranking values in the KMS.

The first and second relevance values may be received from a first user and the third and fourth relevance values may be received from a second user.

The method may further comprise the steps of: receiving a first usefulness value for the first data package and a second usefulness value for the second data package, wherein the first and second usefulness values represent the usefulness of the first and second data parts respectively for the maintenance of the apparatus; and determining that the first and second usefulness values satisfy a threshold.

As noted above, each data package of the plurality of data packages includes a data part relating to maintenance of the apparatus, a first metadata part for the data part having a first metadata value and representing a first contextual information type and a second metadata part for the data part having a second metadata value and representing a second contextual information type. Therefore, a first data package includes a first data part relating to maintenance of the apparatus, a first metadata part for the first data part having a first metadata value and representing a first contextual information type; and a second metadata part for the first data part having a second metadata value and representing a second contextual information type; and a second data package includes a second data part relating to maintenance of the apparatus, a first metadata part for the second data part having a first metadata value and representing the first contextual information type (that is, the first metadata value of this first metadata part of the second data package is distinct to the first metadata value of the first metadata part of the first data package, although both represent the first contextual information type), and a second metadata part for the second data part having a second metadata value and representing the second contextual information type (that is, the second metadata value of this second metadata part of the second data package is distinct to the second metadata value of the second metadata part of the first data package, although both represent the second contextual information type).

According to a second aspect of the invention, there is provided a method of retrieving data of one of a plurality of data packages in a Knowledge Management System (KMS) as a computer system configured to store information on the maintenance of an apparatus, wherein each data package of the plurality of data packages includes a data part relating to the maintenance of the apparatus, a first metadata part relating to the data part having a first metadata value and representing a first contextual information type and a second metadata part relating to the data part having a second metadata value and representing a second contextual information type, and the KMS stores a first ranking value for the first contextual information type and a second ranking value for the second contextual information type, the method comprising the steps of: receiving a data package request including a first metadata value for the first contextual information type and a second metadata value for the second contextual information type; retrieving a first data package of the plurality of data packages based on at least one of the first and second metadata values of the data package request, the first and second ranking values, and at least one of the first and second metadata values of each data package of the plurality of data packages.

The retrieval step may include: determining that the second contextual information type is more relevant than the first contextual information type based on the first and second ranking values; comparing the second metadata value of the data package request to the second metadata value of each data package of the plurality of data packages; and retrieving a first data package of the plurality of data packages based on the comparison of the second metadata values.

Each data package of the plurality of data packages may further include a third metadata part relating to the data part having a third metadata value and representing a third contextual information type, the KMS stores a third ranking value for the third contextual information type, the data package request includes a third metadata value for the third contextual information type, and the method may further comprise the steps of: determining that the third contextual information type is more relevant that the second contextual information type based on the second and third ranking values; comparing the third metadata value of the data package request to the third metadata value of each data package of the plurality of data packages; and retrieving the first data package of the plurality of data packages based on the comparison of the third metadata values.

According to a third aspect of the invention, there is provided a computer program comprising instructions which, when the program is executed by a computer, cause the computer to carry out the steps of the method of the first aspect of the invention. The computer program may be provided on a computer readable carrier medium.

According to a fourth aspect of the invention, there is provided computing apparatus including a communications interface, memory and a processor, which cooperate to carry out the steps of the method of the first and/or second aspect of the invention.

### BRIEF DESCRIPTION OF THE FIGURES

In order that the present invention may be better understood, embodiments thereof will now be described, by way of example only, with reference to the accompanying drawings in which:

FIG. 1 is a schematic diagram of a first embodiment of a computing system of the present invention, as part of a telecommunications network including a telecommunications node and Augmented Reality (AR) device;

FIG. 2 is a schematic diagram of the telecommunications node of FIG. 1;

FIG. 3 is a schematic diagram of the AR device of FIG. 1;

FIG. 4 is a schematic diagram of the computing system of FIG. 1;

FIG. 5 is a flow diagram of a first process of an embodiment of the method of the present invention; and

FIG. 6 is a flow diagram of a second process of the embodiment of the method of the present invention.

### DETAILED DESCRIPTION OF EMBODIMENTS

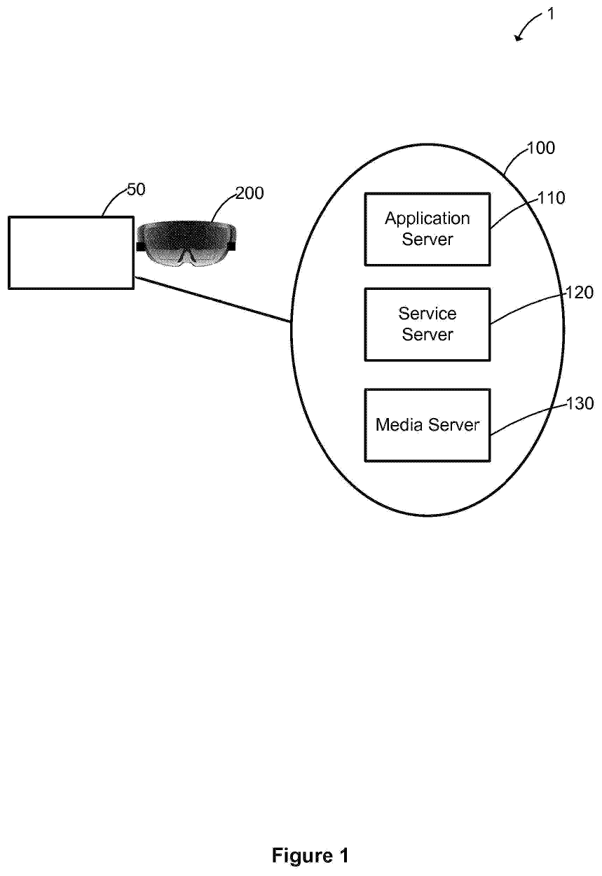

A first embodiment of a telecommunications system 1 of the present invention will now be described with reference to FIGS. 1 to 4. The telecommunications system 1 includes a telecommunications node 50, a computing system 100, and an Augmented Reality (AR) device 200. The Augmented Reality (AR) device 200 is assigned to an agent (e.g. human service engineer), who is tasked with maintaining the telecommunications node 50. This will be explained in more detail when discussing the method of the present invention. First, the components of the telecommunications node 50, computing system 100, and AR device 200 will be detailed.

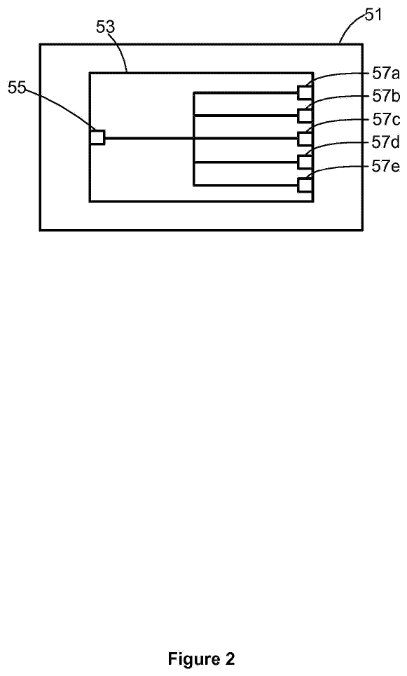

FIG. 2 illustrates the telecommunications node 50 in more detail. In this embodiment, the telecommunications node 50 is a street cabinet of a Digital Subscriber Line (DSL) access network and includes an outer cabinet 51, a DSL Access Multiplier (DSLAM) 53, an optical fibre communications interface 55 (connected upstream to a telephone exchange) and a plurality of twisted copper pair communications interfaces 57a . . . 57e (connected downstream to a plurality of Customer Premises Equipment (CPE)).

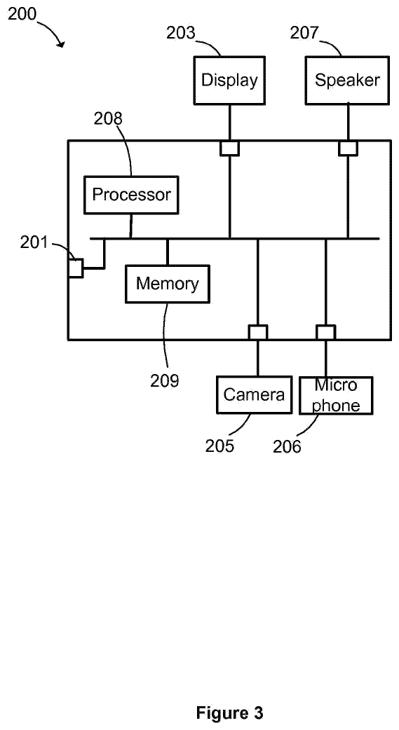

FIG. 3 is a schematic diagram of the AR device 200. In this embodiment, the AR device 200 includes a frame, display 203, camera 205, microphone 206, speaker 207 and an integral processing unit. The frame, display 203 and camera 205 are shaped and configured such that, when worn by the user as a Head Mounted Display (HMD), the display 203 is positioned in front of the user's eyes and the camera 205 captures the user's field of view. The integral processing unit includes a communications interface 201, a processor 208 and memory 209, all connected via a data transfer bus. The processing unit also has communications interfaces to the display 203, camera 205, microphone 206 and speaker 207, such that they may be controlled by and cooperate with the processor 208 and memory 209 (for example, the display 203 cooperates with the processor 208 and memory 209 to display computer-generated images thereon). The communications interface 201 is configured to use a cellular telecommunications protocol (e.g. in cooperation with an antenna), such as Long Term Evolution (LTE), in order to send and receive data with other computing systems. A suitable AR device 200 to be used in this embodiment of the invention is sold under the trade mark Microsoft Hololens, but other AR devices 200 may be used.

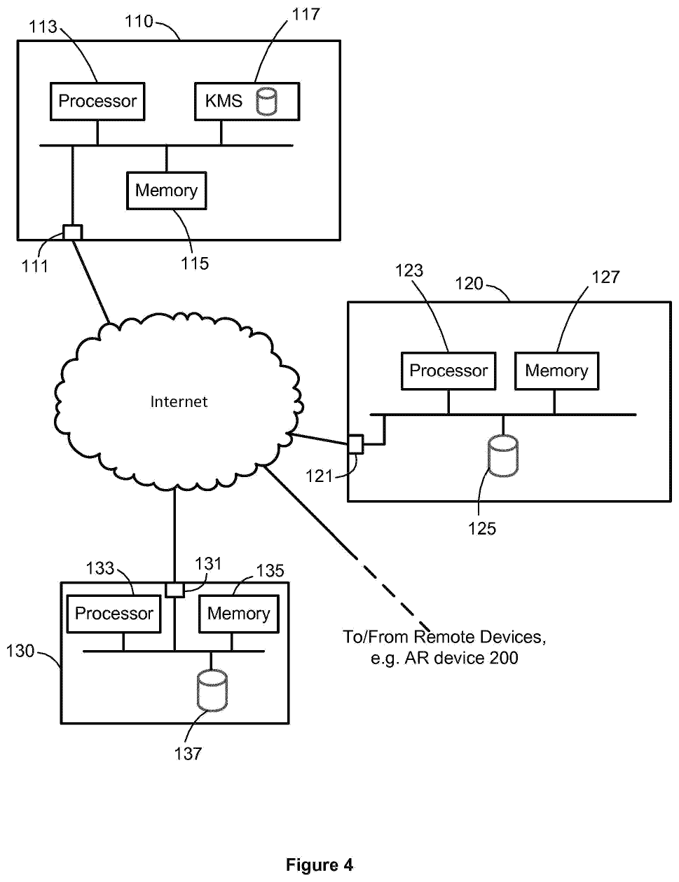

FIG. 4 illustrates the computing system 100 in more detail. The computing system 100 includes an application server 110, a service server 120 and a media server 130. The application server 110 includes a communications interface 111, a processor 113, memory 115, and a Knowledge Management System (KMS), including a KMS database 117, all connected via a data transfer bus. The application server 110 provides a signalling and communication gateway between the service server 120, media server 130 and any remotely connected device, such as the AR device 200, via the Internet.

The media server 130 includes a communications interface 131, a processor 133, memory 135, and a metadata database 137, all connected via a data transfer bus. Memory 135 is configured to store data files relating to the maintenance of a plurality of telecommunications nodes, including the telecommunications node 50 of this embodiment of the invention. These data files will hereinafter be referred to as Knowledge Assets (KA). The metadata database 137 stores metadata for each KA, which will be described in more detail below. The communications interface 131 allows the media server 130 to communicate with the application server 110 and to deliver KAs to any remotely connected device, such as the AR device 200. The media server's communication interface 131 supports a plurality of communications protocols to allow efficient delivery of a variety of KA types to the AR device 200 (such as RTSP, HTTP, Web Sockets, WebRTC, VoIP, TCP/UDP).

The service server 120 includes a communications interface 121, a processor 123, memory 127 and a database 125, again connected by a data transfer bus. The database 125 is configured to store service specific information, such as user profiles. The communications interface 121 allows the service server 120 to communicate with the application server 110.

In overview, the computing system 100 implements two core processes. A first core process begins with the capture of a new KA, such as by the recording of an Audio-Visual (AV) data file by the AR device 200 which relates to the maintenance of the telecommunications node 50, which is then transmitted to the application server 110. The application server 110 is configured to annotate the new KA with metadata, such as an identifier of the telecommunications node, an identifier or other characteristic of the user that transmitted the KA to the application server 110 (which may be obtained from the service server database 125), the location of the telecommunications node, and an identifier of the maintenance task undertaken by the user. Following the creation of the metadata for the KA, the application server 110 sends the KA and its metadata to the media server 130. The media server 130 stores the KA in memory 135 and the associated metadata in the metadata database 137. For the purposes of the following description, the metadata tuple takes the following form:

{KAₘ,ID,M₁*,M₂*, . . . , . . . ,Mₙ*}

Wherein KAₘ ID is an identifier for the m^{th} KA (such as a lookup address for the KA in memory 135), and Mᵢ* is a value for the i^{th} metadata item (in which i is a set of 1 to n) for the m^{th} KA. For example, 1=1 relates to the “Location” metadata item and M₁* takes a value “51.5126258,−0.0997588000000178” for the m^{th} KA, 1=2 relates to the “Equipment Technology” metadata item and M₂* takes a value “DSLAM” for the m^{th} KA, i=3 relates to the “Manufacturer” metadata item and M₃* takes a value “Cisco” for the min KA, etc.

A second core process begins with a request for a KA by a user of the computing system 100. The application server 110 is configured to analyse the request to determine one or more characteristics, such as the telecommunications node it relates to, an identifier or other characteristic of the user (which may be obtained from the service server database 125), or a location of the user. For the purposes of the following description, the KA request tuple takes the following form:

{A₁*,A₂*, . . . Aₙ*}

Wherein Aᵢ* is a value for the i^{th} metadata item in the request. For example, A₁* takes a value “51.5126258,−0.0997588000000178”, A₂* takes a value “DSLAM”, A₃* takes a value “Cisco”, etc. As noted above, some of these values may not be derived directly from the received request, but may be populated following consultation with other entities. For example, the application server 110 may query the service server 120 with a user identifier and, in response, may receive a metadata value for the user's skill level. This may then form a further metadata item, A₄* taking value “Novice”.

The application server 110 may then retrieve a suitable KA from the media server memory 135 based on this data, such as a KA which is classified as relating to that telecommunications node and/or being suitable for that user's skill level. The application server 110 then delivers the KA to the remote device associated with the user (via the communications interface), allowing the user to undertake the maintenance task with the assistance of that KA.

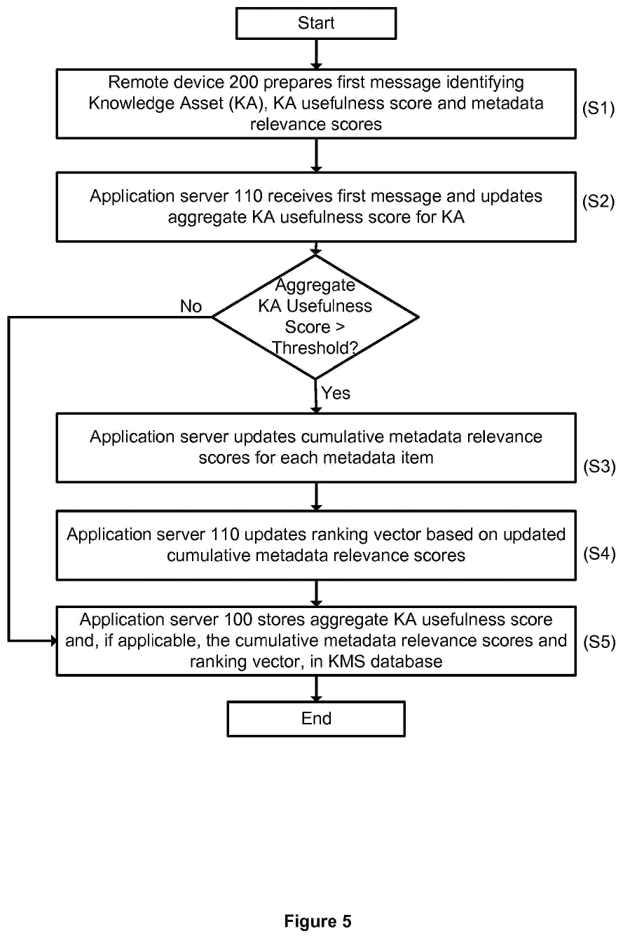

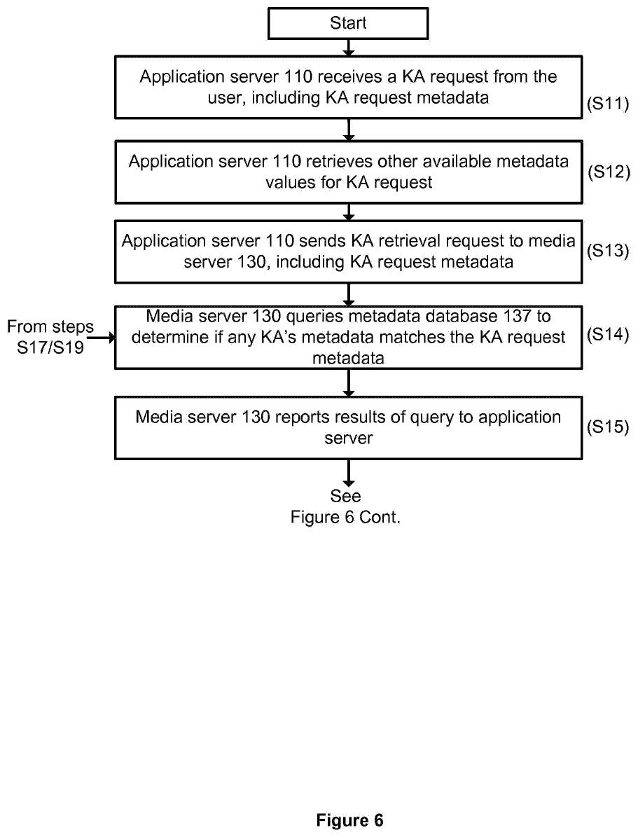

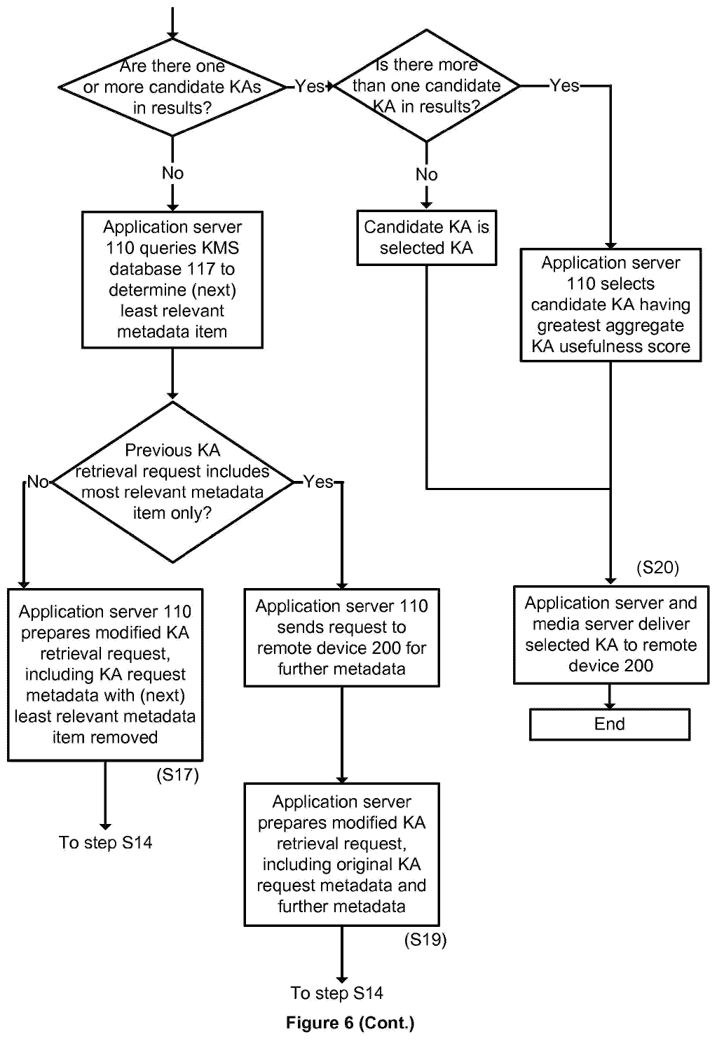

Embodiments of the present invention relate to a method for ranking the usefulness of the metadata items, such that the most relevant KAs may be delivered to a user in a given scenario. An embodiment of the method of the present invention will now be described with reference to FIGS. 5 and 6.

A first process of the embodiment of the present invention is illustrated in the flow diagram of FIG. 5. In this example, the user is wearing the AR device 200, is located at the telecommunications node 50, and is undertaking a maintenance task with the assistance of a KA (previously delivered by the application and media servers 110, 130 of the computing system 100). The KA was an AV file being an AV recording of an experienced service engineer giving step-by-step instructions of how to carry out the same maintenance task on a similar telecommunications node (e.g. a DSLAM having the same manufacturer and model identifiers, but being from a different location). The user views the AV file (using an AV playback application) upon the display 203 of the AR device 200.

Following execution of the KA, the AR device 200 presents a data input form on the display 203, which allows the user to give audio feedback (which may be received via the microphone 206 and processed via a speech-to-text function in the processor) for the KA. In this embodiment, the data input form allows the user to initially input an overall usefulness score of the KA to the maintenance task (hereinafter, “KA usefulness score”). If the KA usefulness score is above a certain threshold (e.g. 80%), then the data input form allows the user to input a relevance score for five metadata items for the KA, “Location”, “Equipment Technology”, “Manufacturer”, “User's Skill”, and “Task Type” indicating the relevance of those metadata items for that KA to the maintenance task (each of these relevance scores will hereinafter be referred to as a “metadata relevance score”). For example, the user may indicate that a KA has a KA usefulness score of 80%, and that the equipment technology, manufacturer, user's skill and task type metadata were all relevant (i.e. the location metadata not being relevant). In step S1, the AR device 200 prepares and sends a first message to the application server 110, wherein the first message includes an identifier for the KA (e.g. a lookup value of the KA within the media server memory 135), the value for the KA usefulness score, and (if applicable) the metadata relevance score for each metadata item.

In step S2, the application server 110 receives the first message and updates an aggregate KA usefulness score for the KA, ƒ(S), stored in KMS database 117, based on the value of the KA usefulness score for the KA. This value is attributed to a single KA and is updated following receipt of each KA usefulness score from any user for that KA. In this embodiment, the function ƒ(S) is a mean of all KA usefulness scores from all users for that KA, which is now updated to take the newly received KA usefulness score (80%) into account.

The application server 110 then determines whether the KA usefulness score from the first message is above the relevant threshold (that is, the same threshold which determines whether the user was presented with the data input form for the metadata relevance score for each metadata item for the KA). If so, then the method proceeds to step S3 (below). If not, then the method proceeds to step S5 (below). In this example, the KA usefulness score from the first message was above the threshold and therefore also includes the metadata relevance score for each metadata item for the KA.

In step S3, these metadata relevance scores are processed by processor 113 to produce a cumulative metadata relevance score for each metadata item by incrementing the following cumulative metadata relevance function:

Cᵢ=(Cᵢ+a)

Where a=1 if the first message indicates that metadata type i was perceived to be relevant in the performance of that maintenance task, and a=0 if the first message indicates that metadata type i was not perceived to be relevant in the performance of that maintenance task. Accordingly, in this example, the value for the cumulative metadata relevance score for “Equipment Technology”, “Manufacturer”, “User's Skill” and “Task Type” (C₂ to C₅) are all incremented by 1, whereas the value for the cumulative metadata relevance score for “Location” (C₁) remains unchanged.

It is noted that the cumulative metadata relevance function, Cᵢ, relates to the relevance of a metadata item for all KAs, such that a relevance score for a metadata item for any KA received from any user is processed to increment the cumulative metadata relevance score for that metadata item.

In step S4, the application server processor 113 also updates a ranking vector, R, which ranks the metadata types according to the values of their respective cumulative metadata relevance scores. The ranking vector is therefore a ranking of the most relevant metadata item (for all KAs for all users) to the least relevant metadata item (for all KAs for all users). In this example, the ranking vector is: R=(3, 4, 1, 5, 2), such that “Manufacturer” is considered the most relevant metadata item, “User's Skill” is considered the second most relevant, “Location” is considered the third most relevant”, “Task Type” is considered the fourth most relevant, and “Equipment Technology” is considered the least relevant.

These two functions (the cumulative metadata relevance function and the ranking vector) are updated each time the application server 110 receives a message from any user indicating the metadata relevance score for metadata items for any KA. That is, these functions are not KA specific (like the aggregate KA usefulness score), but are updated regardless of the KA for which the relevance scores relate to, provided the KA's usefulness was above the relevant threshold).

Thus, as the application server 110 receives KA usefulness scores and metadata relevance scores from many users for many KAs over a period of time, the application server 110 builds ever more accurate values for the aggregate KA usefulness score (for each KA), ever more accurate values for the cumulative metadata relevance score for each metadata item (across all KAs), and an ever more accurate ranking vector (across all KAs).

In step S5, the application server 110 stores the aggregate KA usefulness score and, if applicable, the cumulative metadata relevance scores in the KMS database 117. In this embodiment, the KMS database 117 includes two tables. A first table stores the values of the aggregate KA usefulness score for each KA, ƒ(S), in a tuple having form {KAₘ ID, ƒ(S)ₘ}, wherein KAₘ ID is an identifier for the m^{th} KA (e.g. lookup value of the KA within the media server memory 135) and ƒ(S)m is the aggregate KA usefulness score for the m^{th} KA. A second table of the KMS database 117 stores the value of the cumulative metadata relevance score for each metadata item, in a tuple having form {Cᵢ₌₁, . . . , Cᵢ₌ₙ}, and the values of the ranking vector, in a tuple having form {Rᵢ₌₁ₕ, . . . , Rᵢ₌ₙ}.

The above steps illustrate the process of updating the aggregate KA usefulness score and, if applicable, the cumulative metadata relevance scores and ranking vector, following receipt of the first message. The process ends but is repeated upon receipt of another message from any one of the remote devices (e.g. the AR device 200) including a KA usefulness score and, if applicable, metadata relevance scores for any KA. The significance of these values and their usage are discussed below in the second process of the embodiment of the present invention.

The second process of the embodiment of the present invention will now be described with reference to FIG. 6. An example starting scenario for this process is a user of the AR device 200 being at the location of the telecommunications node 50 and being tasked with the performance of a particular maintenance task (diagnose a fault on a particular DSL, in this case). In a first step of this process (step S11), the user requests a KA to assist him/her in this particular maintenance task. In this example, the user makes the request using a voice command, which is received by the microphone 206, and processed and interpreted by the processor 208. Furthermore, the AR device 200 captures information regarding the telecommunications node 50 such as, in this example, identification of the equipment type and manufacturer of the node 50 using the camera 205 and suitable Optical Character Recognition (OCR) and/or Computer Vision (CV) processes in processor 208, and, in a second example, Global Navigation Satellite System (GNSS) coordinates using components known in the art. The processor 208 then forms a second message, which includes the KA request tuple (as discussed earlier) which has form:

{A₁*,A₂*, . . . Aₙ*}

Wherein Aᵢ* is a value for the i^{th} metadata item in the request. In this example, A₁* relates to metadata item “Location” and takes a value “51.5126258,−0.0997588000000178”, A₂* relates to metadata item “Equipment Technology” and takes a value “DSLAM”, A₃* relates to metadata item “Manufacturer” and takes a value “Cisco”, and A₅* relates to the metadata item “Maintenance Task” and takes value “Diagnose DSL”.

The AR device 200 then transmits the second message to the application server 110 using transceiver 201. The application server 110 receives this message and, in step S12, retrieves any other available data values which are not contained in the KA request. In this example, the data value for A₄*, which relates to metadata item “User Skill”, is not populated. Accordingly, the application server 110 sends a query message to the service server 120 including an identifier for the user, and, in response, receives a value for the metadata item, “User Skill”. In this example, the value for A₄* is “Novice”. In step S13, the application server 110 sends a KA retrieval request to the media server 130, which includes the KA request metadata {A₁*, A₂*, . . . Aₙ*}. On receipt of this request in step S14, the media server's processor 133 queries the metadata database 137 to determine if any metadata tuple has values which exactly match those of the KA request tuple {A₁*, . . . , Aₙ*}. That is, if a metadata tuple for a particular KA also has values, M₁*=“51.5126258,−0.0997588000000178”, M₂*=“DSLAM”, M₃*=“Cisco”, M₄*=“Novice” and M₅*=“Diagnose DSL”, then that KA becomes a candidate KA.

In step S15, the media server 130 determines if the query returns a NULL, one, or more results, and reports this back to the application server 110. If there is a single candidate KA, then it is selected as the KA to be delivered to the user and the process continues with step S20. However, if there is more than one candidate KA, then the application server 110 determines which of the candidate KAs has the greatest aggregate KA usefulness score, ƒ(S), by querying the first table of the KMS database 117. The KA with the greatest aggregate KA usefulness score is then selected as the KA to be delivered to the user and the process proceeds to step S20. However, if the application server 110 is informed of a NULL result (i.e. no KA has metadata items which match those of the KA request) by the media server 130 then, in step S17, the application server prepares a first modified KA retrieval request.

The first modified KA retrieval request takes a similar form to the original KA retrieval request of step S13, {A₁*, A₂*, . . . Aₙ*}. However, in this embodiment, the first modified KA retrieval request is modified by the removal of the metadata item which has been determined as the least relevant based on the ranking vector. Thus, in this embodiment, the application server 110 queries the second table of the KMS database 117 to determine which metadata item is the least relevant (i.e. the metadata item corresponding to the last value in the ranking vector). In this example, the metadata item “Equipment Technology” is returned as the least relevant metadata item. The application server 110 then prepares the first modified KA retrieval request by removing the corresponding metadata item, A₂*, from the KA retrieval request. In other words, the first modified KA retrieval request includes A₁*, A₃*, A₄* and A₅* (relating to “Location”, “Manufacturer”, “User Skill”, “Maintenance Task” respectively). The application server 110 then sends this request to the media server 130.

The media server 130 then queries the metadata database 137 to determine, again, if any metadata tuple {M₁*, . . . , Mₙ₋₁*} has values which exactly match those of the first modified KA request tuple {A₁*, . . . , Aₙ₋₁*} Any result then becomes a candidate KA. The results of this query are then reported back to the application server 110.

If the query for the first modified KA retrieval request again produces a NULL result, then the process is repeated iteratively to determine the next least relevant metadata item (as determined by the ranking vector), prepare a modified KA retrieval request in which the determined next least relevant metadata item is removed, and the media server's response to this request is reviewed for one or more candidate KAs. This process therefore repeats until the media server 130 reports one or more candidate KAs (in which one of these KAs is selected to be delivered to the user using the same logic as detailed in step S15), or until the final modified KA retrieval request for the most relevant metadata item produces a NULL result.

If the final modified KA retrieval request produces a NULL result, then, in step S19, the application server 110 sends a third message to the AR device 200 which includes a request for further metadata. The AR device 200 responds to the request for further metadata by presenting an input screen for further metadata values relating to the maintenance task. In this embodiment, the input screen enables the user to input an additional metadata value for the most relevant metadata item (as determined by the ranking vector) only. The user may input this data by speaking into the microphone 206, which may then be processed and interpreted by the processor 208. If the user wishes to continue, then the user may then input additional metadata values for the 2^{nd} most relevant metadata item, and so on, until he/she indicates that the data entry process is complete. The AR device 200 then sends a fourth message to the application server 110, which includes these additional metadata values.

The application server 110 may then cooperate with the media server 130 to retrieve a suitable KA for the user in a similar manner to before, but the query for retrieving a KA matches the KA's metadata to a broader KA request (in which the metadata values may be either those of the original KA request or the further KA input values). This broader search is therefore more likely to retrieve one or more candidate KAs.

The application server 110 therefore eventually proceeds to step S20 in which the application server 110 coordinates with the media server 130 to deliver the selected KA (i.e. the single candidate KA or the selected KA of a plurality of candidate KAs) to the user. In this embodiment, the media server 130 delivers the selected KA directly to the AR device 200 via the communications interface 131 and the Internet.

The AR device 200 then executes the KA. In this embodiment, the KA is an AV file, such that the display 203 and speaker 207 are controlled by processor 208 to play the AV content to the user. The user then carries out the maintenance task with the assistance of the KA.

The above embodiments of the present invention therefore have the advantages of delivering a more relevant KA to the user, making it more likely that the user will be able to quickly and correctly carry out the maintenance task on a computing apparatus. Thus, many improvements may be realised in the system containing the computing apparatus, such as reduced repair times and reduced fault rates. This improvement is realised by selecting a KA based on the most relevant metadata items, as determined by a number of users (in other words, the relevance of the metadata items are “crowdsourced”).

In the above embodiments, the media server 130 may report more than one candidate KA to the application server 110, and the application server 130 then selects one of these KAs to deliver to the user. The skilled person will understand that this is non-essential, as the application server 130 may deliver several or all of these candidate KAs, and the user may then make a selection.

Furthermore, in a modification to the above embodiment, the application server 110 may refine the results of the candidate KAs to remove any candidate KA that has received a low (e.g. less than a threshold) KA usefulness score from the user making the request for a KA. In this scenario, the KMS database 117 must store the KA usefulness score for each KA from each user in addition to updating the aggregate KA usefulness score.

Furthermore, upon selection of a candidate KA to deliver to the user, the computing system 100 may further personalise the KA before delivery (e.g. based on the identity and known characteristics of the user and/or telecommunication node being maintained). In the above embodiments, the metadata relevance score for each metadata item is a binary score. That is, the user deems the metadata item to be “relevant” or “not relevant”, and this is used to update a cumulative metadata relevance score for each metadata item. However, this is non-essential and other methods of recording and aggregating each metadata item's relevance may be used. For example, the user may give the metadata relevance score as a percentage, and the application server 110 may then update an aggregate metadata relevance score based on a mean of the metadata relevance scores from all users for all KAs. The ranking vector may then rank the relevance of the metadata items based on the mean percentage value.

Embodiments of the present invention provide a means to rank metadata items according to the relevance of the contextual information of each metadata item to the maintenance of the computing apparatus. This ranking process is agnostic to the KA and to the user giving feedback on the relevance of that contextual information. The ranking vector is just one example by which this ranking may be stored such that the KAs may be retrieved with a preference for those with more highly ranked metadata items. However, the ranking vector is non-essential and any function which conveys the relevance of each metadata item relative to other metadata items may be used.

The skilled person will also understand that it is non-essential for the components on the computing system 100 to be distributed over several separate nodes. That is, embodiments of the method of the present invention may be implemented in a single computing apparatus.

Insofar as embodiments of the invention described are implementable, at least in part, using a software-controlled programmable processing device, such as a microprocessor, digital signal processor or other processing device, data processing apparatus or system, it will be appreciated that a computer program for configuring a programmable device, apparatus or system to implement the foregoing described methods is envisaged as an aspect of the present invention. The computer program may be embodied as source code or undergo compilation for implementation on a processing device, apparatus or system or may be embodied as object code, for example.

Suitably, the computer program is stored on a carrier medium in machine or device readable form, for example in solid-state memory, magnetic memory such as disk or tape, optically or magneto-optically readable memory such as compact disk or digital versatile disk etc., and the processing device utilises the program or a part thereof to configure it for operation. The computer program may be supplied from a remote source embodied in a communications medium such as an electronic signal, radio frequency carrier wave or optical carrier wave. Such carrier media are also envisaged as aspects of the present invention.

It will be understood by those skilled in the art that, although the present invention has been described in relation to the above described example embodiments, the invention is not limited thereto and that there are many possible variations and modifications which fall within the scope of the invention.

The scope of the present invention includes any novel features or combination of features disclosed herein. The applicant hereby gives notice that new claims may be formulated to such features or combination of features during prosecution of this application or of any such further applications derived therefrom. In particular, with reference to the appended claims, features from dependent claims may be combined with those of the independent claims and features from respective independent claims may be combined in any appropriate manner and not merely in the specific combinations enumerated in the claims.

What is claimed is:

1. A method for ranking contextual data of a plurality of data packages in a Knowledge Management System (KMS) as a computer system configured to store information on the maintenance of an apparatus, wherein each data package of the plurality of data packages includes a data part relating to maintenance of the apparatus, a first metadata part for the data part having a first metadata value and representing a first contextual information type and a second metadata part for the data part having a second metadata value and representing a second contextual information type, the method comprising the steps of:
receiving a first and second relevance value for the first and second contextual information type respectively for a first data package, wherein the first and second relevance values represent the relevance of the first and second contextual information types of the first data part to the maintenance of the apparatus;
receiving a third and fourth relevance value for the first and second contextual information type respectively for a second data package, wherein the third and fourth relevance values represent the relevance of the first and second contextual information types of the second data part to the maintenance of the apparatus;
determining a first ranking value for the first contextual information type based on the first and third relevance values;
determining a second ranking value for the second contextual information type based on the second and fourth relevance values; and
storing the first and second ranking values in the KMS.

2. A method as claimed in claim 1, wherein the first and second relevance values are received from a first user and the third and fourth relevance values are received from a second user.

3. A method as claimed in claim 1, further comprising the steps of:
receiving a first usefulness value for the first data package and a second usefulness value for the second data package, wherein the first and second usefulness values represent the usefulness of the first and second data parts respectively for the maintenance of the apparatus; and
determining that the first and second usefulness values satisfy a threshold.

4. A method as claimed in claim 1, further comprising the step of:
receiving a fifth and sixth relevance value for the first and second contextual information type respectively for the first data package, wherein the fifth and sixth relevance values represent the relevance of the first and second contextual information types of the first data part to the maintenance of the apparatus;
wherein the first ranking value for the first contextual information type is determined based on the first, third and fifth relevance values, and the second ranking value for the second contextual information type is determined based on the second, fourth and sixth relevance values.

5. A computer program product comprising instructions which, when the program is executed by a computer, cause the computer to carry out the steps of claim 1.

6. A non-transitory computer readable carrier medium storing a computer program, which upon execution of the computer program by a computer, causes the computer to perform the steps of claim 1.

7. A computing apparatus including a communications interface, memory and a processor, which cooperate to carry out the steps of claim 1.
